(19) United States
(12) Patent Application Publication
(10) Pub. No.: US 2008/0039072 A1
(43) Pub. Date: Feb. 14, 2008

(54) MOBILE RADIO TERMINAL WITH HEADSET ASSEMBLY HAVING MULTI-FUNCTION USER INPUT BUTTON AND METHOD

(76) Inventor: L. Scott Bloebaum, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/463,919

(22) Filed: Aug. 11, 2006

(51) Int. Cl. H04Q 7/20

(52) U.S. Cl. 455/425

(57) ABSTRACT

A method of controlling a mobile radio terminal includes assigning a non-call related function to a call answer button of a headset assembly that is operatively interfaced with the mobile radio terminal. In response to a detection of a depression of the button when no incoming call is received and when no call is in progress, the function is performed.

### TECHNICAL FIELD OF THE INVENTION

The present invention relates generally to a user input device for electronic equipment, such as electronic equipment for engaging in voice communications. More particularly, the invention relates to an interaction between a mobile radio terminal and a headset assembly to enhance the functionality of a call answer button provided as part of the headset assembly.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and hands-free headset interfaces.

Mobile telephones are often used with a personal handsfree assembly. Handsfree assemblies come in many configurations. Some have a wired interface for operatively connecting with the mobile telephone and others have a wireless interface. An exemplary handsfree assembly has a pair of speakers that are wearable in respective ears of the user to allow the user to listen to stereo music and to hear an audio component of a telephone call. A microphone may be provided, such as on a boom or on a housing secured to a wire that connects the speakers to the mobile telephone. The housing that retains the microphone also may include a button that the user may depressed to answer an incoming call or to terminate a call. For instance, when an incoming call is detected by the mobile telephone, the mobile telephone may play a ring tone through the speakers of the handsfree assembly. Upon depression of the button, any audio that is played back to the user through the handsfree assembly may be paused and the telephone call may be carried out in conventional fashion using the speakers and microphone of the handsfree assembly.

### SUMMARY

To improve user interaction with electronic devices, there is a need in the art for enhanced functionality and improved user control over the electronic devices using conveniently accessible user input devices.

According to one aspect of the invention, a method of controlling a mobile radio terminal includes assigning a non-call related function to a call answer button of a headset assembly that is operatively interfaced with the mobile radio terminal; detecting depression of the button when no incoming call is received and when no call is in progress; and performing the function in response to the detection.

According to one embodiment of the method, performing the function is operative to change audiovisual content playback.

According to one embodiment of the method, the function is pausing the audiovisual content playback.

According to one embodiment of the method, a subsequent depression of the button is operative to resume paused audiovisual content playback.

According to one embodiment of the method, the function is dependent on a sequence of associated button depressions.

According to one embodiment of the method, the function is dependent on a duration of button depression.

According to one embodiment of the method, the function is user selectable from plural menu choices.

According to one embodiment of the method, the function is user selectable as a duplication of a function associated with a key integrated with the mobile radio terminal.

According to another aspect of the invention, a method of controlling a mobile radio terminal includes detecting a depression of a button that is physically associated with a headset assembly that is operatively interfaced to the mobile radio terminal; and performing a function associated with the depression of the button for a current operational mode of the mobile radio terminal, wherein functions associated with the depression of the button include answer an incoming call in an incoming call handling mode of the mobile radio terminal and, in the absence of an incoming call, change audiovisual content playback in an audiovisual content playback mode of the mobile radio terminal.

According to one embodiment of the method, the function to change audiovisual content playback is pausing the audiovisual content playback.

According to one embodiment of the method, a subsequent depression of the button is operative to resume paused audiovisual content playback.

According to one embodiment of the method, the function to change audiovisual content playback is dependent on a sequence of button depressions.

According to one embodiment of the method, the function to change audiovisual content playback is dependent on a duration of button depression.

According to one embodiment of the method, the function to change audiovisual content playback is user selectable from plural menu choices.

According to one embodiment of the method, the function to change audiovisual content playback is user selectable as a duplication of a function associated with a key integrated with the mobile radio terminal.

According to another aspect of the invention, a mobile radio terminal is configured to receive a command input from an operatively interfaced headset assembly and includes a radio circuit for establishing calls; and a control circuit that executes logical instructions to: assign a non-call related function to a call answer button of the headset assembly; detect depression of the button when no incoming call is received by the radio circuit and when no call is in progress; and command performance of the function in response to the detection.

According to one embodiment of the mobile radio terminal, performance of the function is operative to change audiovisual content playback.

According to one embodiment of the mobile radio terminal, the function is pausing the audiovisual content playback.

According to another aspect of the invention, a mobile radio terminal is configured to receive a command input from an operatively interfaced headset assembly and includes a radio circuit for establishing calls; and a control circuit that executes logical instructions to: detect a depression of a button that is physically associated with the headset assembly; and command performance of a function associated with the depression of the button for a current operational mode of the mobile radio terminal, wherein functions associated with the depression of the button include answer an incoming call received by the radio circuit in an incoming call handling mode of the mobile radio terminal and, in the absence of an incoming call, change audiovisual content playback in an audiovisual content playback mode of the mobile radio terminal.

According to one embodiment of the mobile radio terminal, the function to change audiovisual content playback is pausing the audiovisual content playback.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone with a headset assembly as an exemplary electronic equipment assembly in accordance with an embodiment of the present invention;

FIG. 2 is a schematic block diagram of the relevant portions of the electronic equipment assembly of FIG. 1 in accordance with an embodiment of the present invention;

FIG. 3 is a schematic diagram of a communications system in which the mobile telephone of FIG. 1 may operate; and

FIG. 4 is a flow chart representing an exemplary method of controlling the mobile telephone with the headset assembly in accordance with an embodiment of the present invention.

### DETAILED DESCRIPTION OF EMBODIMENTS

The present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment, examples of which include a media player, a gaming device and a computer. Aspects of the invention are directed to the interaction of an electronic device and a headset assembly. Headset assemblies are often referred to as handsfree devices or as personal handsfree (PHF) units. The headset assembly may have a wired or wireless interface with the associated electronic device.

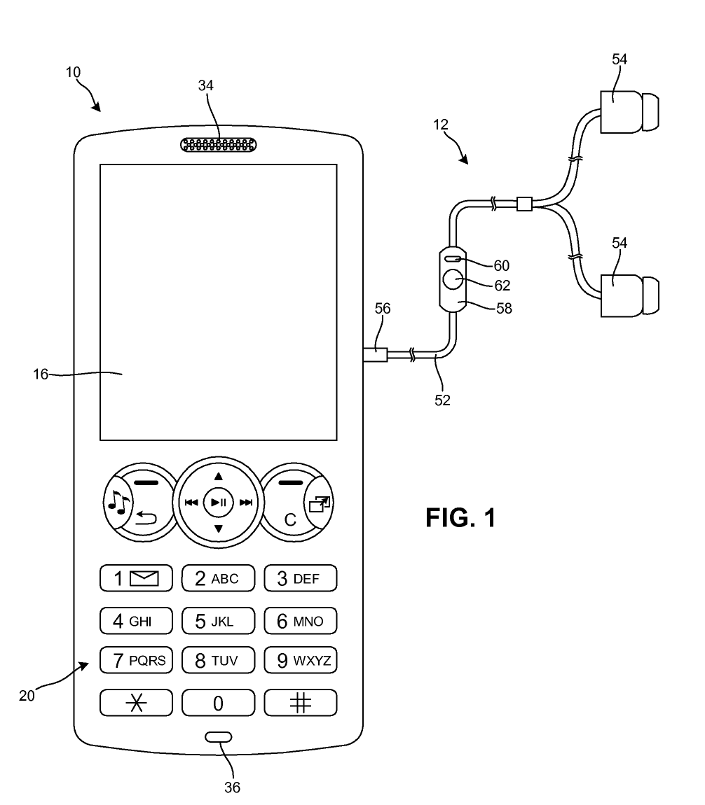

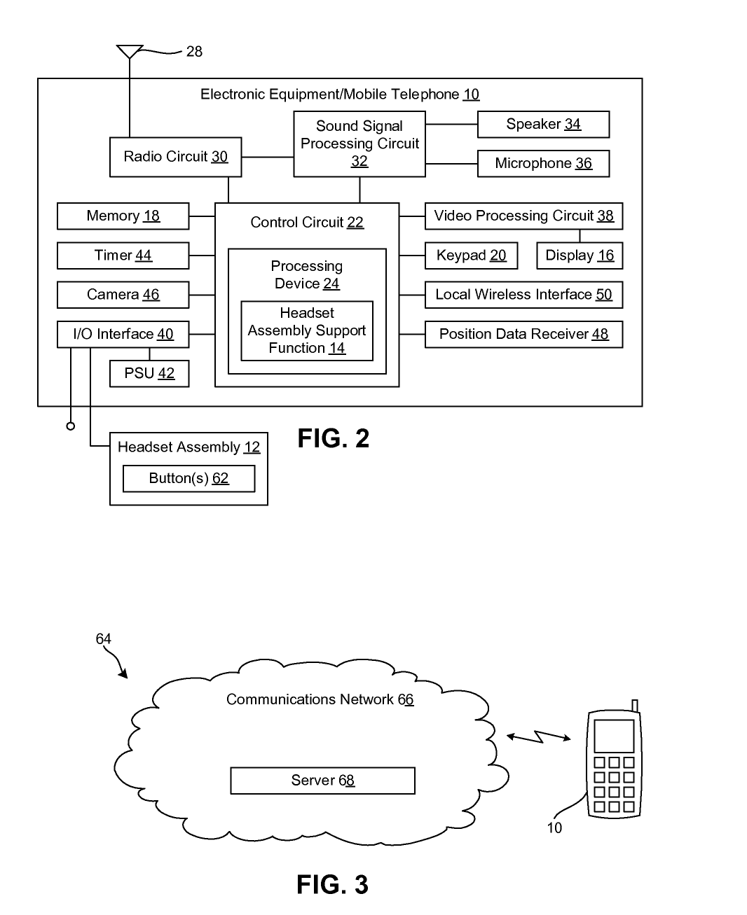

Referring initially to FIGS. 1 and 2, an electronic device 10 is shown. The electronic device 10 is operatively coupled to a headset assembly 12 that is configured to act as a user input device. The headset assembly 12 also is configured to playback audio to the user and to allow a user to converse with a remotely located individual using a telephone function of the election device 10. Details of the headset assembly 12 will be described in greater detail below. It will be appreciated that the headset assembly 12 may operate in conjunction with any appropriate software drivers and/or hardware controllers of the electronic device 10, including, for example, executable code that may be resident in and executed by the electronic equipment 10. For instance, the electronic device 10 may execute a headset assembly support function 14 that is embodied as executable code. In one embodiment, the headset assembly support function 14 may be a program stored on a computer or machine readable medium. The headset assembly support function 14 may be a stand-alone software application or form a part of a software application that carries out additional tasks related to the electronic device 10.

The electronic equipment of the illustrated embodiment is a mobile telephone and will be referred to as the mobile telephone 10. The mobile telephone 10 is shown as having a “brick” or “block” form factor housing, but it will be appreciated that other type housings, such as a clamshell housing or a slide-type housing, may be utilized.

The mobile telephone 10 may include a display 16. The display 16 displays information to a user such as operating state, time, telephone numbers, contact information, various navigational menus, etc., which enable the user to utilize the various features of the mobile telephone 10. The display 16 also may be used to visually display content received by the mobile telephone 10 and/or retrieved from a memory 18 of the mobile telephone 10. The display may be used to present images, video and other graphics to the user, such as photographs, mobile television content and video associated with games.

A keypad 20 provides for a variety of user input operations. For example, the keypad 20 typically includes alphanumeric keys for allowing entry of alphanumeric information such as telephone numbers, phone lists, contact information, notes, etc. In addition, the keypad 20 typically includes special function keys such as a “call send” key for initiating or answering a call, and a “call end” key for ending or “hanging up” a call. Special function keys may also include menu navigation and select keys, for example, for navigating through a menu displayed on the display 16 to select different telephone functions, profiles, settings, etc., as is conventional. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. For the sake of brevity, generally conventional features of the mobile telephone 10 will not be described in great detail herein. The mobile telephone 10 includes a primary control circuit 22 that is configured to carry out overall control of the functions and operations of the mobile telephone 10. The control circuit 22 may include a processing device 24, such as a CPU, microcontroller or microprocessor. The processing device 24 executes code stored in a memory (not shown) within the control circuit 22 and/or in a separate memory, such as memory 18, in order to carry out operation of the mobile telephone 10. The memory 18 may be, for example, one or more of a buffer, a flash memory, a hard drive, a removable media, a volatile memory, a non-volatile memory or other suitable device.

In addition, the processing device 24 may execute code that supports or interacts with the headset assembly 12. For example, the headset assembly support function 14 may be executed by the processing device 24 to convert signals from the headset assembly 12 into commands for other programs executed by the processing device 24 or elsewhere in the mobile telephone 10. It will be apparent to a person having ordinary skill in the art of computer programming, and specifically in application programming for mobile telephones or other electronic devices, how to program a mobile telephone 10 to operate and carry out logical functions associated with interfacing to the headset assembly 12 and/or control various mobile telephone functions in accordance with signals received from the headset assembly 12. Accordingly, details as to specific programming code have been left out for the sake of brevity. Also, while the headset assembly support function 14 is executed by the processing device 24 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc as well as advanced versions of these standards.

The mobile telephone 10 further includes a sound signal processing circuit 32 for processing audio signals transmitted by and received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 22 so as to carry out overall operation. Audio data may be passed from the control circuit 22 to the sound signal processing circuit 32 for playback to the user. The audio data may include, for example, audio data from an audio file stored by the memory 18 and retrieved by the control circuit 24, or received audio data such as in the form of streaming audio data from a mobile radio service. The sound processing circuit 30 may include any appropriate buffers, decoders, amplifiers and so forth.

The display 16 may be coupled to the control circuit 22 by a video processing circuit 38 that converts video data to a video signal used to drive the display 14. The video processing circuit 38 may include any appropriate buffers, decoders, video data processors and so forth. The video data may be generated by the control circuit 22, retrieved from a video file that is stored in the memory 18, derived from an incoming video data stream received by the radio circuit 30 or obtained by any other suitable method.

The mobile telephone 10 further includes one or more I/O interface(s) 40. The I/O interface(s) 40 may be in the form of typical mobile telephone I/O interfaces and may include one or more electrical connectors. As is typical, the I/O interface(s) 40 may be used to couple the mobile telephone 10 to a battery charger to charge a battery of a power supply unit (PSU) 42 within the mobile telephone 10. In addition, or in the alternative, the I/O interface(s) 40 may serve to connect the mobile telephone 10 to the headset assembly 12 in an embodiment where the headset assembly 12 has a wired interface with the mobile telephone 10. Further, the I/O interface(s) 40 may serve to connect the mobile telephone 10 to a personal computer or other device via a data cable for the exchange of data. The mobile telephone 10 may receive operating power via the I/O interface(s) 40 when connected to a vehicle power adapter or an electricity outlet power adapter.

The mobile telephone 10 may also include a timer 44 for carrying out timing functions. Such functions may include timing the durations of calls, generating the content of time and date stamps, etc. The mobile telephone 10 may include a camera 46 for taking digital pictures and/or movies. Image and/or video files corresponding to the pictures and/or movies may be stored in the memory 18. The mobile telephone 10 also may include a position data receiver 48, such as a global positioning system (GPS) receiver, Galileo satellite system receiver or the like. The mobile telephone 10 also may include a local wireless interface 50, such as an infrared transceiver and/or an RF adaptor (e.g., a Bluetooth adapter), for establishing communication with an accessory, another mobile radio terminal, a computer or another device. For example, the local wireless interface 50 may operatively couple the mobile telephone 10 to the headset assembly 12 in an embodiment where the headset assembly 12 has a wireless interface.

The mobile telephone 10 may be configured to transmit, receive and process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in the memory 18, executing applications to allow user interaction with data, displaying video and/or image content associated with the data, outputting audio sounds associated with the data and so forth.

Focusing now on the headset assembly 12, the headset assembly 12 may have a wired interface 52 to the mobile telephone 10 as depicted in the attached figures or a wireless interface (e.g., a Bluetooth interface). The headset assembly 12 may include at least one speaker 54 for outputting audible sounds to the user. In the illustrated embodiment, there are two speakers 54 for stereo audio playback to the user. The illustrated speakers 54 are arranged as “ear buds” so that the speakers 54 may be retained by partial insertion into the left and right ears of the user, respectively.

Along the wired pathway between the speakers 54 and a jack 56 that establishes electrical connection with the mobile telephone 10 is a housing 58. The housing 58 may retain a microphone 60 for detecting speech of a user when the user carries out a telephone conversation using the call functionality of the mobile telephone 10.

The housing 58 also may retain a button 62. Depression of the button 62 results in the input of a detectable signal into the control circuit 22 or other appropriate component of the mobile telephone 10. The signal may be any suitable electrical waveform, such as a logical high or logical low generated during button depression or a particular waveform associated with the button. As will be described below, the signal may correspond to one or more control instructions. The signal may be generated for the entire time that the button 62 is depressed or for a fixed duration no matter how long the button is depressed. The button 62 may be implemented as a momentary switch that closes a circuit pathway to change a voltage at a particular circuit node or as part of circuitry in the housing 58 that generates the signal. In one embodiment, the headset 12 includes one button that, when depressed, inputs a single corresponding signal to the mobile telephone 10. In other embodiments, the headset 12 may include plural buttons that, when individually depressed, each input a corresponding signal to the mobile telephone 10.

In other embodiments, the headset 12 may have a wireless interface to the mobile telephone 10. In this case, the button(s) 62 may be located on a housing that also retains the speaker(s) 54, the microphone 60 and/or wireless interface circuitry. In one arrangement, the button 62 may be located on a housing that is connected with wires to another headset 12 component. In the wireless interface embodiment, digital audio data may be exchanged between the headset 12 and the mobile telephone 10 for decoding by the receiving one of the headset 12 or the mobile telephone 10. In the wired embodiment, sound data to be audibly output to the user may be decoded by the sound signal processing circuit 32 and delivered to the headset 12 as analog signals for application to the speaker(s) 54. Also, in the wired embodiment, the microphone 60 may input an analog audio signal to the mobile telephone 10 for encoding by the sound signal processing circuit 32.

As will be appreciated, wired and wireless headset assemblies may be arranged in a multitude of manners and aspects of the invention are not intended to be limited to the illustrated or described headset arrangements. For instance, the speaker(s) may be retained by a housing (or respective housings) that hooks over the user's ear, the microphone may be disposed on a boom or may detect sounds emanating from the user's ear canal rather than from the user's mouth, the button(s) 62 may be located on a housing that retains the speaker(s), and so forth.

With additional reference to FIG. 3, the mobile telephone 10 may be configured to operate as part of a communications system 64. The system 64 may include a communications network 66 having a server 68 (or servers) for managing calls placed by and destined to the mobile telephone 10, transmitting data to the mobile telephone 10 and carrying out any other support functions. The server 68 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 66 may support the communications activity of multiple mobile telephones 10 and other types of end user devices. As will be appreciated, the server 68 may be configured as a typical computer system used to carry out server functions and may include a processor configured to execute software containing logical instructions that embody the functions of the server 68.

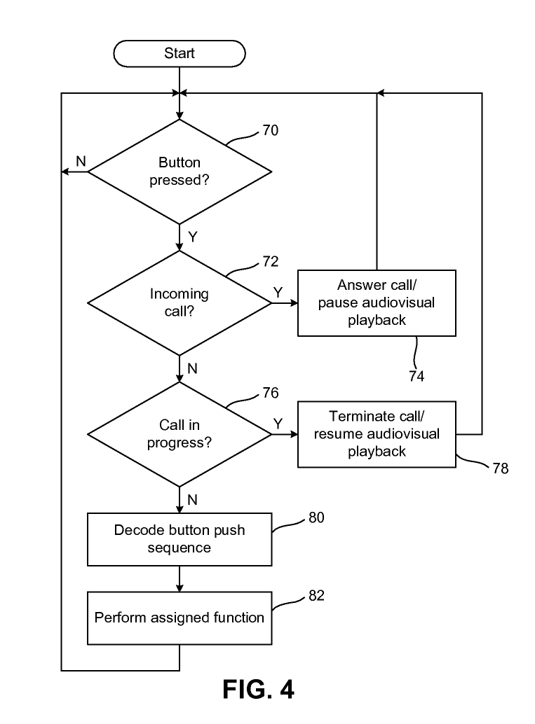

With additional reference to FIG. 4, illustrated are logical operations performed by the mobile telephone 10 when executing the headset assembly support function 14. The flow chart of FIG. 4 may be thought of as depicting steps of a method carried out by the mobile telephone 10. Although FIG. 4 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

As indicated, buttons on headsets have been used to answer incoming calls or terminate calls. Aspects of the present invention adds functionality to the button 62 during other operational modes of the mobile telephone 10. For example, the button 62 may be used during audiovisual content playback to pause and resume the playback. As used herein, audiovisual content includes, but is not limited to, content having only an audio component, content having only a video component and content having both audio and video components. The audiovisual content playback may be any form of audiovisual playback including, for example, playback of a stored audio or video file, playback of a podcast, playback of streaming audio or video, and so forth. Other exemplary functions may include returning to the beginning of the current track in a playlist, forwarding to the beginning of the next track, increasing or decreasing audio playback volume and so forth.

The particular function performed in response to depression of the button may be programmed (e.g., selected) by the user. For instance, a menu or other graphical user interface may allow the user to select the function of the button from several choices. Alternatively, the function associated with the button may be selected by instructing the mobile telephone 10 to duplicate the function performed by an existing key on the mobile telephone 10, such as a key from the keypad 20. Also, different functions may be associated with the button for different operational modes of the mobile telephone 10.

In one embodiment, more than one function may be associated with the button. For example, the function may be variable based on the number of button depressions occurring within a particular amount of time (e.g., a time window commencing with a previous depression), similar to the way a mouse button may be pressed to generate different responses for one “click,” two “clicks,” or three “clicks.” By way of example, one depression of the button 62 may pause audiovisual playback (or resume playback if the content is already pause), two depressions in rapid succession may move the playback back one track and three depression in rapid succession may move the playback ahead one track. The decoding of plural button depressions as a single user input command may be based on the time between each successive depression. For instance, if depressions are made in succession with less than a predetermined amount of time between each adjacent depression in the series of depressions, a correlation between the number of depressions and an association function may be made. The predetermined amount of time between depressions may be, for example, less than a tenth of second, less than three tenths of a second, less than half a second or some other appropriate length of time.

The logical flow may commence in block 70 where a determination may be made as to whether the button 62 has been pressed. A positive determination made be if the signal corresponding to button 62 depression is detected by the mobile telephone 10. If the button 62 has not been depressed, no signal may be detected and a negative determination may be made. If a negative determination is made in block 70, the logical process may wait until a positive determination is made.

Upon a positive determination in block 70, the logical flow may proceed to block 72. In block 72 a determination made be may as to whether there is an incoming call for the mobile telephone 10. The incoming call may take any suitable form. For example, the call could be a conventional call that is established over a cellular circuit-switched network or a voice over Internet Protocol (VoIP) call that is established over a packet-switched capability of the cellular network or over an alternative packet-switched network, such as WiFi, WiMax, etc. Another example includes a video enabled call that is established over a cellular or alternative network.

If there is an incoming call, the function associated with depression of the button 62 may be to answer the call. Accordingly, upon a positive determination in block 72, the logical flow may proceed to block 74. In block 74, the call may be answered. If audiovisual content was being played prior to receipt of the incoming call, depression of the button 62 also may lead to pausing, stopping or muting the audiovisual playback to reduce distraction to the user while carrying out a conversation with the calling party.

If there is no incoming call a negative determination may be made in block 72 and the logical flow may proceed to block 76. In block 76 a determination may be made as to whether a call is in progress. The call in progress may take any suitable form. For example, the call could be a conventional call that is established over a cellular circuit-switched network or a voice over Internet Protocol (VoIP) call that is established over a packet-switched capability of the cellular network or over an alternative packet-switched network, such as WiFi, WiMax, etc. Another example includes a video enabled call that is established over a cellular or alternative network.

If the mobile telephone 10 is currently used to carryout a call, the function associated with depression of the button may be to terminate the call. It is noted that the call termination function may be assigned regardless of whether the call was initiated using the mobile telephone 10 or was an incoming call. Accordingly, upon a positive determination in block 76, the logical flow may proceed to block 78. In block 78, the call may be terminated. If audiovisual content was being played prior to call that resulted in a positive determination in block 76, depression of the button also may lead to resuming the audiovisual playback.

If there is no call in progress, a negative determination may be made in block 76 and the logical flow may proceed to block 80. In block 80, a sequence of button depressions may be decoded and, in block 82, a function associated with the decoded sequence may be carried out. For instance, if one depression is made without a subsequent depression in a predetermined amount of time, a function associated with a single button depression may be carried out. As indicated, such a function may be to pause audiovisual content that is currently being played back or resume the playback of paused audiovisual content. As another example, if a first depression is followed by a second depression within a predetermined amount of time, a function associated with a double depression may be carried out. One such function may be to jump backward one track in a playlist (sometimes referred to as a repeat function). As another example, if a first depression is followed by a second depression within a predetermined amount of time and the second depression is followed by a third depression within a predetermined amount of time, a function associated with a triple depression may be carried out. One such function may be to jump forward one track in a playlist (sometimes referred to as a skip function). Other functions while playing back audiovisual content that may be associated with various button depression sequences include increasing or decreasing volume, scrolling through various volume settings, scrolling through a playlist, and so on.

In one embodiment, button functionality may be dependent on the result of an earlier carried out function, such as the above-mentioned resumption of audiovisual content playback after pausing of the audiovisual content. Another example may be that a first depression is used to commence a preview operation for items in a playlist by scrolling through the playlist and playing the first few seconds of the content (e.g., about five to ten seconds) for each item or announcing header data for each item. A second depression is used to select an item for normal playback.

In other embodiments, the duration of button depression may be used by the user to invoke the execution of a certain function. For example, tapping the button 62 may be used to reduce playback volume and holding the depression of the button 62 may be used to increase volume. As another example, long button depressions (e.g., a depression lasting longer than a half of a second or longer than a second), short button depressions (e.g., a depression lasting shorter than a quarter or a third of a second) and/or combinations of long and short button depressions may be used in invoke the executions of associated functions.

In other embodiments, multiple buttons 62 may form part of the headset 12. Each button 62 may have dedicated functionality. Alternatively, the functionality of each button 62 may be settable (e.g., by selecting from menu options or by programming) by the user. Also, depression sequences in terms of the number and timing of depressions for a particular button 62, the duration of depressions and/or the use of two or more buttons 62 at the same time or in sequence may be used to generate a set of user input commands that may vary from one operational mode of the mobile telephone (e.g., during telephone call handling) to another operational mode of the mobile telephone (e.g., audiovisual content playback).

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of controlling a mobile radio terminal, comprising:
assigning a non-call related function to a call answer button of a headset assembly that is operatively interfaced with the mobile radio terminal;
detecting depression of the button when no incoming call is received and when no call is in progress; and
performing the function in response to the detection.

2. The method of claim 1, wherein performing the function is operative to change audiovisual content playback.

3. The method of claim 2, wherein the function is pausing the audiovisual content playback.

4. The method of claim 3, wherein a subsequent depression of the button is operative to resume paused audiovisual content playback.

5. The method of claim 1, wherein the function is dependent on a sequence of associated button depressions.

6. The method of claim 1, wherein the function is dependent on a duration of button depression.

7. The method of claim 1, wherein the function is user selectable from plural menu choices.

8. The method of claim 1, wherein the function is user selectable as a duplication of a function associated with a key integrated with the mobile radio terminal.

9. A method of controlling a mobile radio terminal, comprising:
detecting a depression of a button that is physically associated with a headset assembly that is operatively interfaced to the mobile radio terminal; and
performing a function associated with the depression of the button for a current operational mode of the mobile radio terminal, wherein functions associated with the depression of the button include answer an incoming call in an incoming call handling mode of the mobile radio terminal and, in the absence of an incoming call, change audiovisual content playback in an audiovisual content playback mode of the mobile radio terminal.

10. The method of claim 9, wherein the function to change audiovisual content playback is pausing the audiovisual content playback.

11. The method of claim 10, wherein a subsequent depression of the button is operative to resume paused audiovisual content playback.

12. The method of claim 9, wherein the function to change audiovisual content playback is dependent on a sequence of button depressions.

13. The method of claim 9, wherein the function to change audiovisual content playback is dependent on a duration of button depression.

14. The method of claim 9, wherein the function to change audiovisual content playback is user selectable from plural menu choices.

15. The method of claim 9, wherein the function to change audiovisual content playback is user selectable as a duplication of a function associated with a key integrated with the mobile radio terminal.

16. A mobile radio terminal configured to receive a command input from an operatively interfaced headset assembly, comprising:
a radio circuit for establishing calls; and
a control circuit that executes logical instructions to:
assign a non-call related function to a call answer button of the headset assembly;
detect depression of the button when no incoming call is received by the radio circuit and when no call is in progress; and
command performance of the function in response to the detection.

17. The mobile radio terminal of claim 16, wherein performance of the function is operative to change audiovisual content playback.

18. The mobile radio terminal of claim 17, wherein the function is pausing the audiovisual content playback.

19. A mobile radio terminal configured to receive a command input from an operatively interfaced headset assembly, comprising:
a radio circuit for establishing calls; and
a control circuit that executes logical instructions to:
detect a depression of a button that is physically associated with the headset assembly; and
command performance of a function associated with the depression of the button for a current operational mode of the mobile radio terminal, wherein functions associated with the depression of the button include answer an incoming call received by the radio circuit in an incoming call handling mode of the mobile radio terminal and, in the absence of an incoming call, change audiovisual content playback in an audiovisual content playback mode of the mobile radio terminal.

20. The mobile radio terminal of claim 19, wherein the function to change audiovisual content playback is pausing the audiovisual content playback.
